(19) United States
(12) Patent Application Publication
(10) Pub. No.: US 2012/0232894 A1
(43) Pub. Date: Sep. 13, 2012

(54) DEVICE FOR RECONSTRUCTING SPEECH BY ULTRASONICALLY PROBING THE VOCAL APPARATUS

(75) Inventors: Thomas Hueber, Grenoble (FR); Bruce Denby, Paris (FR); Gérard Dreyfus, Gif Sur Yvette (FR); Rémi Dubois, Paris (FR); Perrie Roussel, Paris (FR)

(73) Assignees: CENTRE NATIONAL DE LA RECHERCHE SCIENTIFIQUE, Paris (FR); UNIVERSITE PIERRE ET MARIE CURIE (PARIS 6), Paris (FR)

(21) Appl. No.: 13/496,617

(22) PCT Filed: Sep. 15, 2010
(86) PCT No.: PCT/EP2010/005651

§ 371 Date: May 29, 2012

(30) Foreign Application Priority Data
Sep. 17, 2009 (FR) 0904444

(51) Int. Cl. G10L 15/28; G01S 15/06

(52) U.S. Cl. 704/231; 704/E15.046

(57) ABSTRACT

The invention provides a portable device for recognizing and/or reconstructing speech by ultrasound probing of the vocal apparatus, the device including at least one ultrasound transducer (20) for generating an ultrasound wave and for receiving a wave reflected by the user's vocal apparatus, and analysis means for analyzing a signal generated by the ultrasound transducer, wherein the device includes locating means (21, 23) for determining the position of the ultrasound transducer relative to the skull of the user.

The invention relates to a device for recognizing and/or reconstituting speech by ultrasound probing of the vocal apparatus.

### BACKGROUND OF THE INVENTION

Proposals have been made to recognize or reconstitute speech by ultrasound imaging of the vocal apparatus. Reference may be made for example to the article entitled “Speech synthesis from real time ultrasound images of the tongue” by Bruce Denby and Maureen Stone, published at the 2004 IEEE International Conference on Acoustics, Speech, and Signal Processing—ICASSPO4-Montreal, May 17-21, 2004. For that purpose, use is generally made of an ultrasound probe that implements a series of ultrasound transceivers, in practice transceivers of the piezoelectric type, that are suitable for emitting ultrasound waves and for receiving reflected waves so as to transform them into electrical signals; or alternatively, if this is possible in the application, use is made of a single ultrasound transducer.

Proposals have also been made to use low frequency ultrasound that propagates in air for use in a similar application. The ultrasound transducer(s) is/are advantageously associated with a telephone handset so as to be close to the vocal apparatus when the user is telephoning.

Nevertheless, the relative position(s) of the ultrasound sensor(s) relative to the user's head cannot be known accurately, depending essentially on the way in which the user holds the device. This makes the signals from the ultrasound sensors more difficult to analyze.

In order to avoid that problem, proposals have been made in certain experimental devices to prevent the user's head from moving relative to the ultrasound sensor, such that analysis of the signal generated by the ultrasound sensors is not affected by any uncertainty concerning their positions relative to the head (see in particular the head and transducer support system (HATS) that can be seen at the following address: http://speech.umaryland.ed/ahats.html, and that is described in the 1995 article by M. Stone, and E. Davis “A head and transducer support system for making ultrasound images of tongue/jaw movement”, Journal of the Acoustical Society of America, 1995, 98(6), pp. 3107-3112.

In the proposed device, an ultrasound probe is positioned under the lower jaw and does not move with it. Its position relative to a given frame of reference is thus determined with certainty, the head itself being held stationary and its position being determined in said frame of reference, such that the angle of incidence at which the ultrasound waves are sent towards the vocal apparatus is known at all times, thereby making the signals easier to analyze. Nevertheless, that type of device is naturally not practical for use in everyday life.

### OBJECT OF THE INVENTION

The invention seeks to propose a portable device for recognizing and/or reconstructing speech by ultrasound probing of the vocal apparatus, wherein the analysis of the signal from ultrasound sensor(s) is made easier.

### BRIEF DESCRIPTION OF THE INVENTION

To this end, the invention provides a portable device for recognizing and/or reconstructing speech by ultrasound probing of the vocal apparatus, the device including at least one ultrasound transducer for generating an ultrasound wave and for receiving a wave reflected by the vocal apparatus, and analysis means for analyzing a signal generated by the ultrasound transducer. According to the invention, the device includes locating means for determining the position of the ultrasound transducer relative to the skull of the user.

Since the ultrasound transducer is not stationary relative to the vocal apparatus, it is important to determine how it moves in three dimensions relative to a frame of reference associated with the user's skull, in order to determine the angle at which the ultrasound waves strike the vocal apparatus, and in particular its articulatory elements. Knowledge of the angle of incidence makes it possible to separate movement of the ultrasound transducer from movement of the articulatory elements, given that it is only the movement of those elements that is of use in recognizing or reconstructing speech. This makes signal analysis much easier.

### BRIEF DESCRIPTION OF THE FIGURES

The invention can be better understood in the light of the following description of particular embodiments of the invention with reference to the figures of the accompanying drawing, in which:

FIG. 1 is a perspective view showing a device in a first particular embodiment of the invention, while being worn by a user;

FIG. 2 is a perspective view showing a device in a second particular embodiment of the invention, while being worn by a user; and

FIG. 3 is a diagrammatic perspective view showing how, from a measurement of the three components of acceleration due to gravity, it is possible to deduce the orientation of a frame of reference associated with the accelerometer.

### DETAILED DESCRIPTION OF THE INVENTION

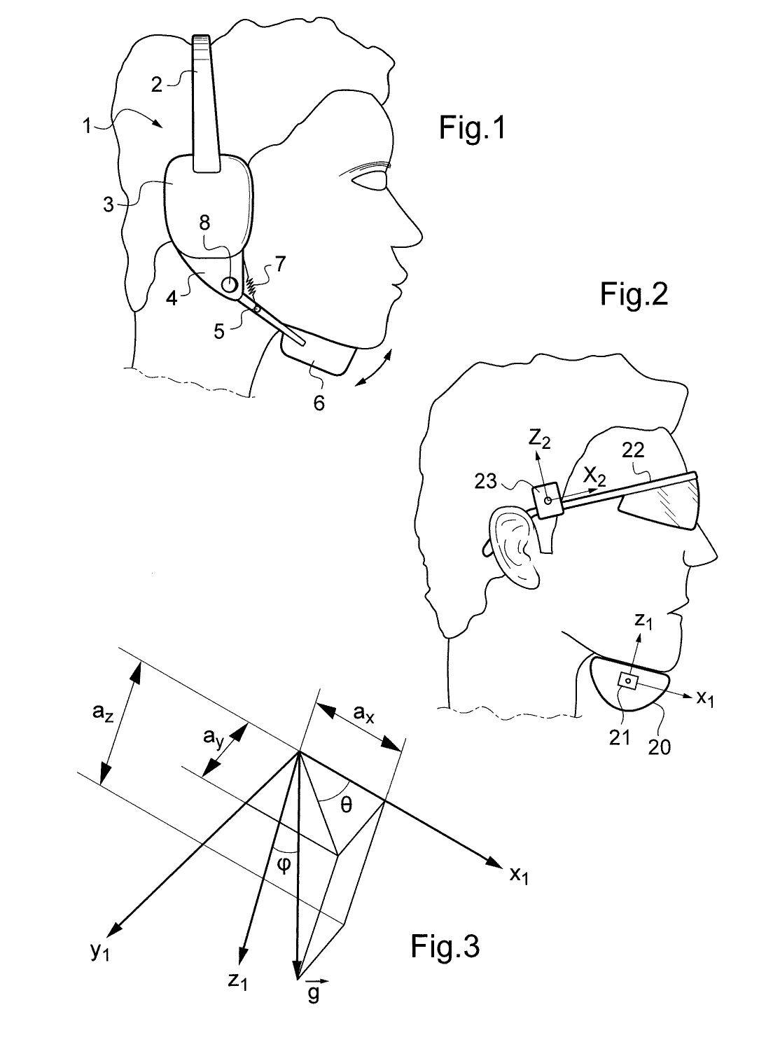

With reference to FIG. 1, the device of the invention comprises a headset 1 with a headband 2 carrying earpieces 3. One of the earpieces includes a bottom extension 4 having an arm 5 pivotally mounted thereon about a hinge axis that is substantially parallel to the hinge axis of the jaw that is itself movable relative to the skull. The end of the arm 5 carries an ultrasound sensor 6 that may be placed under the lower jaw and that is urged against it by a spring 7 coupled between the arm 5 and the bottom extension 4. The ultrasound sensor 6 is thus pressed continuously against the jaw and follows its movements.

The headset 1 includes analysis means (specifically a processor executing specialized software) for analyzing the signal delivered by the ultrasound sensor in order to deduce the user's speech therefrom (even if the user is articulating silently).

According to the invention, the headset 1 is fitted with means for determining the angular position of the arm relative to the headband of the headset. Specifically, these means comprise a rotation sensor 8 at the hinge of the arm 5, that delivers a signal that is applied to the analysis means. By means of this sensor, it is possible at all times to know the angle of the arm relative to the remainder of the headset 1, and thus to deduce therefrom the angular position of the ultrasound sensor relative to the headset. Assuming that the headset is stationary relative to the user's skull, it is thus possible to deduce therefrom the angle of incidence of the ultrasound radiation relative to the end of the oral cavity. The analysis means takes advantage of this information in order to make better use of the signal generated by the ultrasound sensor.

In a second particular embodiment as shown in FIG. 2, the device of the invention comprises an ultrasound probe 20 made up of a series of synchronized ultrasound transducers and that can be held in the hand, or held in position by a collar or a chin-strap, or indeed arranged at the end of a telephone handset.

The ultrasound probe 20 is for use together with an object carried by the user and held stationary relative to the user's skull, specifically in this example a pair of eyeglasses 22 worn by the user of the ultrasound probe 20.

The ultrasound probe 20 and the pair of eyeglasses 22 are fitted with locating means (given respective references 21 and 23) making it possible to determine the position of the ultrasound probe 20 relative to the pair of eyeglasses 22. The eyeglasses are assumed to be stationary relative to the user's skull, and a position of the ultrasound probe relative to the skull is deduced therefrom.

In a particular embodiment, the location means comprise three-channel accelerometers 21, 23 carried respectively by the ultrasound probe 20 and by the pair of eyeglasses 22.

In known manner, accelerometers are used as inclinometers in order to determine two angles of inclination of a reference frame relative to a vertical axis defined by the local direction of gravity. Thus, the accelerometers serve to determine (ignoring any rotation about the above-mentioned vertical axis) the angular positions of the ultrasound probe 20 and of the pair of eyeglasses 22 (respectively a reference frame R1 of axes x₁, y₁, z₁ for the ultrasound probe and a reference frame R2 of axes x₂, y₂, and z₂ for the pair of eyeglasses).

By way of illustration, FIG. 3 shows how, from three measured acceleration components aₓ, a_{y}, and aₓ that satisfy the relationship:

aₓ²+a_{y}²+a_{z}²=g²

in the absence of any significant accelerated movements, it is possible to reconstitute two angles serving to identify the angular position of the frame of reference relative to the vertical as defined by gravity (ignoring any rotation about the vertical direction). The angles θ and φ satisfy the following relationships:

$$\{ \begin{matrix}{a}_{x} = ‖ {g}^{l} ‖ sin ϕ cos θ \\ {a}_{y} = ‖ {g}^{r} ‖ sin ϕ sin θ \\ {a}_{z} = ‖ {g}^{r} ‖ cos ϕ\end{matrix} \}$$

In order to lift the uncertainty associated with the angular position about the vertical axis, the accelerometers may be associated with gyros that provide the missing angle. Otherwise, prior to use, it is appropriate to co-ordinate the reference frames R1 and R2 relative to each other so as to be able subsequently to identify the positions of the ultrasound probe 20 and of the pair of eyeglasses 22, and deduce therefrom their relative position by taking the difference.

The accelerometers 21 and 23 are preferably placed on the ultrasound probe 20 and on the pair of eyeglasses 22 in such a manner that a plane of one of the reference frames is substantially coplanar with a plane of the other reference frame when the user is holding the ultrasound probe in a reference position (as shown in FIG. 2 where the planes (x₁, z₁) and (x₂, z₂) are coplanar). Prior to use of the ultrasound probe 20, a prior co-ordination procedure may be implemented in order to guide the user (e.g. by emitting audible beeps) so as to place the ultrasound probe in the reference position, thereby angularly positioning the ultrasound probe 20 relative to the pair of eyeglasses 22 prior to any use of the device.

Thereafter, any movement of the ultrasound probe 20 relative to the pair of eyeglasses 22 is detected merely by comparing the measurements from the accelerometers 21 and 23, thus making it possible at any instant to know the position of the ultrasound probe 20 relative to the skull, and thus the orientation of the ultrasound probe relative to the end of the oral cavity. The accelerometers arranged in this way together form means for locating the probe relative to the user's skull.

For this purpose, communications means (wired or wireless) connected to the accelerometers serve to deliver the measured position to calculation means associated with the analysis means so as to act in real time to determine the angular orientation of the ultrasound probe, and to enable that position to be taken into account while analyzing the signal from the probe. By way of example, the calculation means may be constituted by a processor included in the telephone having the ultrasound probe positioned at its end.

The invention is not limited to the above description, but covers any variant coming within the ambit defined by the claims.

In particular, although the ultrasound transducer(s) (sensors, probe) in the embodiment described is/are used to probe the oral cavity and thus to track the movements of the tongue, it is possible more generally to use the ultrasound transducer(s) to probe the vocal apparatus, e.g. the movement of the lips.

The device of the invention may include other sensors that generate signals suitable for assisting in recognizing or reconstructing speech, e.g. a camera filming the movement of the lips.

Naturally, other locating means may be used in the ambit of the invention, such as for example inertial units associated respectively with the item that is stationary relative to the skull and with the ultrasound probe. Furthermore, it is naturally possible for any item to be used as the stationary element providing it remains stationary relative to the skull while in use, for example a helmet, an earpiece, a hat, . . . .

What is claimed is:

1. A portable device for recognizing and/or reconstructing speech by ultrasound probing of the vocal apparatus, the device including at least one ultrasound transducer (6, 20) for generating an ultrasound wave and for receiving a wave reflected by the user's vocal apparatus, and analysis means for analyzing a signal generated by the ultrasound transducer, wherein the device includes locating means (8; 21, 23) for determining the position of the ultrasound transducer relative to the skull of the user.

2. A device according to claim 1, wherein the locating means comprise an angular position sensor for sensing the angular position of an arm (5) hinged to a headset (1) and having the ultrasound transducer carried at the end thereof.

3. A device according to claim 1, wherein the locating means comprise first locating means (21) secured to the ultrasound transducer, second locating means (23) secured to an item worn by the user so as to be stationary relative to the user's skull, and calculation means for deducing therefrom the position of the probe relative to the skull.

4. A device according to claim 3, wherein each of the locating means comprises at least one three-channel accelerometer.
